(19) United States
(12) Patent Application Publication
(10) Pub. No.: US 2026/0332899 A1
(43) Pub. Date: Oct. 22, 2026

(54) CONTROL SYSTEM, VEHICLE AND METHOD

(71) Applicant: JAGUAR LAND ROVER LIMITED, Warwickshire (GB)

(72) Inventors: Tom EVANS, Whitley, Coventry, Warwickshire (GB); Ersin KURNAZ, Whitley, Coventry, Warwickshire (GB)

(21) Appl. No.: 19/491,511

(22) PCT Filed: Jun. 5, 2024
(86) PCT No.: PCT/EP2024/065487

§ 371 Date: Dec. 9, 2025

(30) Foreign Application Priority Data
Jun. 9, 2023 (GB) 2308599.6

(51) Int. Cl. H04N 23/73; H04N 23/90

(52) U.S. Cl. CPC H04N 23/73; H04N 23/90

(57) ABSTRACT

A control system for controlling a camera system of a vehicle is configured to receive motion data of the vehicle, determine whether to operate the camera system of the vehicle in a fixed exposure control mode or an automatic exposure control mode using the motion data, and output, to the camera system of the vehicle, a control signal to request the camera system to operate in the fixed exposure control mode or the automatic exposure control mode in accordance with the determination. The control system may be incorporated into the vehicle with one or more cameras and may operate in accordance with a method of controlling the camera system.

### TECHNICAL FIELD

The present disclosure relates to a vehicle control system and control method for controlling a camera system of a vehicle. Aspects of the invention relate to a control system, a system, a vehicle, and a method. Particularly, but not exclusively, the disclosure relates to a road or off-road vehicle, and particularly, but not exclusively, an EGO vehicle (i.e., a vehicle that is equipped with autonomous or semi-autonomous driving technology and is capable of sensing and navigating its environment without direct input from a human driver).

### BACKGROUND

It is known to provide advanced driver assistance systems (ADAS) camera systems for vehicles in the form of human vision-based cameras and environmental perception-based cameras. Traditionally, ADAS camera systems are tuned with adaptive exposure time based on statistics from a scene. For example, an exposure time of pixels of a camera of the ADAS system may be progressively increased as the scene becomes darker to obtain images having a higher signal to noise ratio. However, increasing the exposure time can introduce undesirable side effects in the obtained images, such as motion artefacts if there are objects in the scene, and motion blur if a vehicle has speed.

It is an aim of the present invention to address one or more of the disadvantages associated with the prior art.

### SUMMARY OF THE INVENTION

Aspects and embodiments of the invention provide a control system, a system, a vehicle, a method, and computer readable instructions as claimed in the appended claims.

This disclosure provides a technique for improving image quality obtained from vehicular camera systems. The technique selects between a fixed exposure control mode and an automatic exposure control mode depending on factors relevant to a vehicle.

According to an aspect of the present invention there is provided a control system for controlling a camera system of a vehicle, the control system comprising one or more controllers. The control system is configured to receive motion data of the vehicle. The control system is further configured to determine whether to operate the camera system of the vehicle in a fixed exposure control mode or an automatic exposure control mode using the motion data (“a determination”). The control system is further configured to output, to the camera system of the vehicle, a control signal to request the camera system to operate in the fixed exposure control mode or the automatic exposure control mode in accordance with the determination.

In this way, an appropriate exposure control mode can be determined for use by the camera system based on the vehicle motion data at a given time. For example, when a driver is manoeuvring a vehicle in a way in which motion blur is less likely to occur, the control system can determine that the camera system should be operated in the automatic exposure control mode such that high quality images, (i.e., images having a high signal to noise ratio) are provided to the driver by the camera system with little or reduced levels of motion blur.

The control system comprises one or more controllers collectively comprising at least one electronic processor having an electrical input for receiving an input signal comprising motion data of the vehicle; and at least one memory device electrically coupled to the at least one electronic processor and having instructions stored therein; and wherein the at least one electronic processor is configured to access the at least one memory device and execute the instructions thereon so as to: to receive motion data of the vehicle; determine whether to operate the camera system of the vehicle in a fixed exposure control mode or an automatic exposure control mode using the motion data (“a determination”); and to output, to the camera system of the vehicle, a control signal to request the camera system to operate in the fixed exposure control mode or the automatic exposure control mode in accordance with the determination.

Optionally, the control system is configured to compare the motion data to a threshold to determine whether to operate the camera system of the vehicle in the fixed exposure control mode or the automatic exposure control mode. By setting the threshold accordingly, the level of motion blur can be reduced and managed to an acceptable level.

Optionally, the control system is configured to output a control signal to request the camera system to operate in one of the automatic exposure control mode and the fixed exposure control mode when the motion data is below the threshold and to operate in the other of the automatic exposure control mode and the fixed exposure control mode when the motion data is above the threshold.

Optionally, the threshold is set such that a level of motion blur in the automatic exposure control mode does not exceed a motion blur threshold.

Optionally, the threshold is at a first value when the motion data is indicative of increasing vehicle motion and at a second value when the motion data is indicative of decreasing vehicle motion. In this way, a deliberate hysteresis is introduced to prevent switching modes when the motion is hunting around the threshold.

Optionally, the determination causes the control signal to request the camera system to operate in the automatic exposure control mode at lower vehicle motion than the fixed exposure control mode. As motion blur is less prevalent for relatively low vehicle motion as compared to relatively high vehicle motion, the camera system can be operated in the automatic exposure control mode at relatively low vehicle motion to allow for images having an increased signal to noise ratio to be captured by the camera system.

Optionally, the control system is further configured to receive ambient light data of an environment surrounding the vehicle, and wherein the determination is based on the motion data and the ambient light data. By considering ambient light data in the environment surrounding the vehicle in addition to the motion data, the control system can determine when to activate the automatic exposure control mode such that images having a high signal to noise ratio and minimised motion blur are captured by the camera system.

The control system is configured to determine the threshold using a threshold function based on the ambient light data. At relatively low levels of ambient light, camera exposure times may need to be increased to improve the signal to noise ratio of captured images. However, as vehicle motion increases, an increased camera exposure time can lead to increased motion blur. By considering the threshold as a threshold function of ambient light data, the control system can determine an appropriate switching point for operation in the automatic exposure control mode such that images having an enhanced signal to noise ratio and reduced motion blur can be captured.

Optionally, when the ambient light data indicates relatively low ambient light, the threshold is reduced so that the motion data is at a lower value before the determination causes the control signal to request the camera system to operate in the automatic exposure control mode. In this way, images with a high signal to noise ratio can be captured that have reduced motion blur artefacts.

Optionally, the determination causes the control signal to request the camera system to operate in the automatic exposure control mode based on the motion data only when the ambient light data is greater than a predetermined ambient light level. In this way, the automatic exposure control mode is not activated in dark conditions which would cause or risk motion blur artefacts at a given motion of the vehicle.

Optionally, the motion data comprises vehicle speed data and vehicle steering data. The prevalence of motion blur artefacts tends to increase at progressively higher speeds and at progressively higher steering angles. By considering both vehicle speed data and vehicle steering data, the control system can determine an appropriate point at which to operate the camera system in the automatic exposure control mode such that motion blur artefacts are at least reduced to an acceptable level.

Optionally, the camera system is one or more of: a human vision camera system, a rear-view human vision camera system, a three-dimensional surround view camera system, and an environmental perception camera system. For example, the environmental perception camera system may form part of an automatic emergency brake system, a lane keep assist system and/or an autonomous parking system.

According to another aspect of the invention, there is provided a system comprising the control system as mentioned above and one or more cameras mounted on a vehicle.

According to yet another aspect of the invention, there is provided a vehicle comprising the system as mentioned above, or the control system as mentioned above.

According to a still further aspect of the invention, there are provided computer readable instructions which, when executed by a computer, are arranged to perform the method as mentioned above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a block diagram illustrating a control system according to an embodiment of the present invention;

FIG. 2a is a schematic illustration of a vehicle according to an embodiment of the present invention;

FIG. 2b is a schematic illustration of a rear-view of the vehicle of FIG. 2a;

FIG. 3 a first flowchart showing operations performed by the control system of FIG. 1 according to an embodiment of the present invention;

FIG. 4 is a second flowchart showing operations performed by the control system according to an embodiment of the present invention;

FIG. 5 is a graph illustrating vehicle motion as a function of time and a vehicle motion threshold;

FIG. 6 is a schematic illustration of a vehicle according to an embodiment of the present invention; and

FIG. 7 is a third flowchart showing operations performed by the control system according to an embodiment of the present invention.

### DETAILED DESCRIPTION

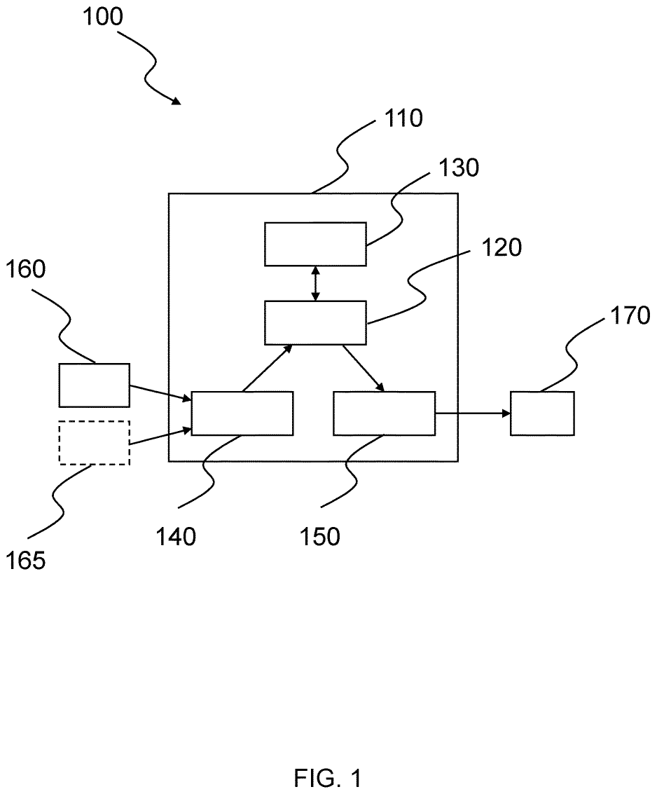

With reference to FIG. 1, there is illustrated a control system 100 for a vehicle. The control system 100 as illustrated in FIG. 1 comprises one controller 110, although it will be appreciated that this is merely illustrative. The controller 110 comprises processing means 120 and memory means 130. The processing means 120 may be one or more electronic processing device 120 which operably executes computer-readable instructions. The memory means 130 may be one or more memory devices 130. The memory means 130 is electrically coupled to the processing means 120. The memory means 130 is configured to store instructions, and the processing means 120 is configured to access the memory means 130 and execute the instructions stored thereon.

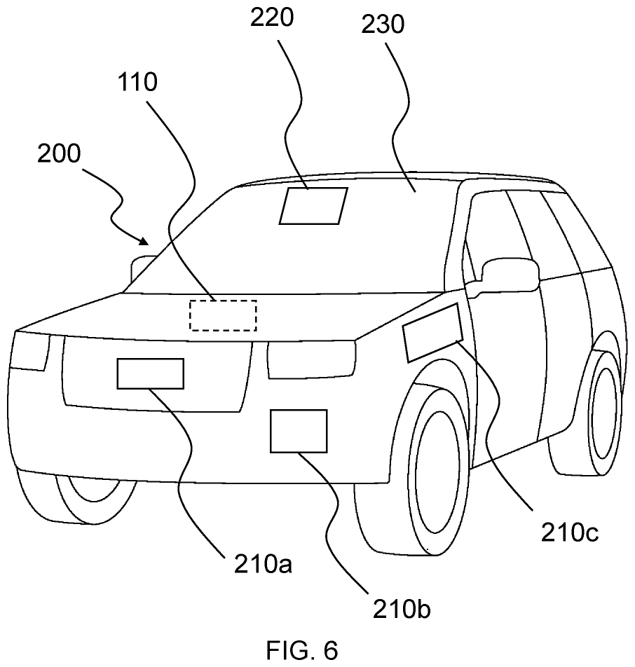

The controller 110 comprises an input means 140 and an output means 150. The input means 140 may comprise an electrical input 140 of the controller 110. The output means 150 may comprise an electrical output signal 170 of the controller 110. The input means 140 is arranged to receive a vehicle motion signal 160 from a vehicle motion sensor of the vehicle. The input means may optionally be arranged to receive an ambient light signal 165 (discussed further below with respect to FIG. 6) from an ambient light sensor of the vehicle. The vehicle motion signal 160 is an electrical signal which is indicative of one or more motion characteristics of the vehicle. The output means 150 is arranged to output a control signal 170 to a camera system of the vehicle to request the camera system to operate in a fixed exposure/aperture control mode or an automatic exposure/aperture control mode.

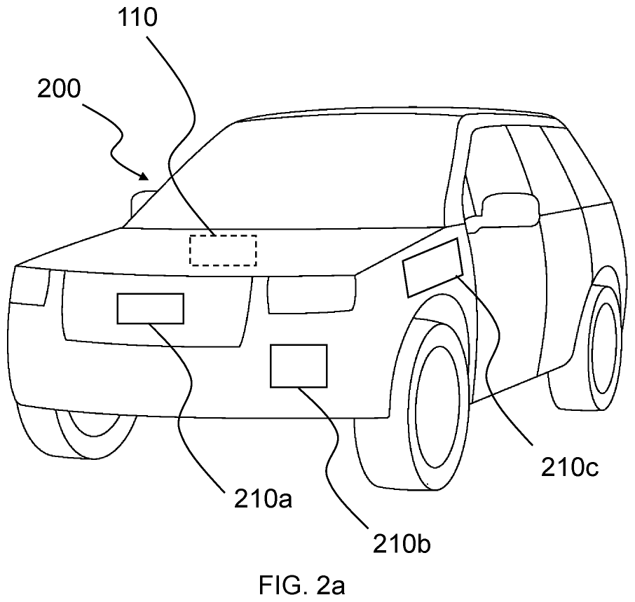

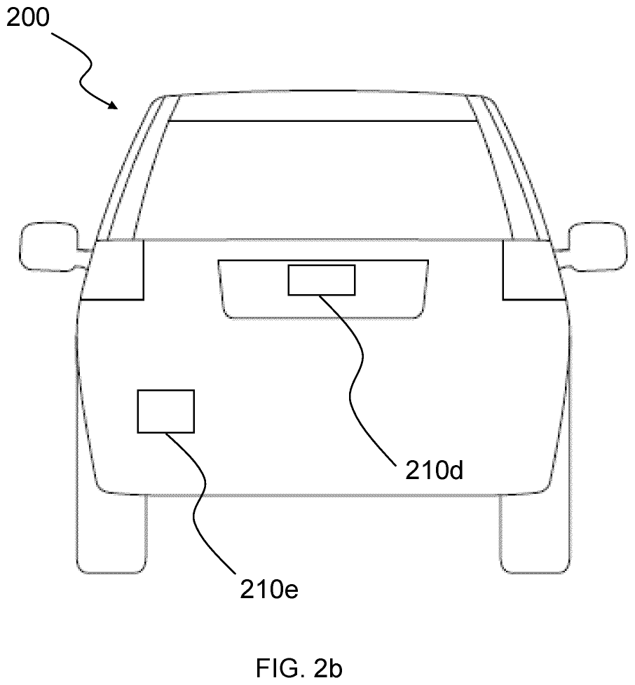

FIG. 2a illustrates a vehicle 200 according to an embodiment of the present invention. The vehicle 200 comprises a controller 110 as illustrated in FIG. 1. The controller 110 is shown mounted within the vehicle 200 and is in communication with one or more camera systems located on the vehicle 200 such that control signals 170 can be transmitted to the one or more camera systems located on the vehicle 200.

Vehicle 200 may be an EGO vehicle, i.e., a vehicle that is equipped with autonomous or semi-autonomous driving technology and is capable of sensing and navigating its environment without direct input from a human driver.

Vehicle 200 has at least one camera system (210a-e) located on the vehicle for capturing images of an environment surrounding the vehicle 200. For example, vehicle 200 may have a first front-facing camera system 210a arranged to capture images at the front of the vehicle 200, and a second front-facing camera system 210b arranged to capture images at the front of the vehicle 200. The first front-facing camera system 210a may be a human vision-based camera system. For example, the first front-facing camera system 210a may be a see-through bonnet camera system or may be part of a three-dimensional surround-view camera system. The second front-facing camera system 210b may be an environmental perception-based camera system. For example, the second front-facing camera system 210b may be part of a traffic sign recognition system, an auto emergency brake system, a lane keep assist system and/or an autonomous parking system. The vehicle 200 may also have one or more side-facing camera systems 210c arranged to capture images at a side surface of the vehicle 200. The one or more side-facing camera systems 210c may be part of human vision-based camera systems and/or environmental perception-based camera systems.

FIG. 2b illustrates a rear-view of the vehicle 200 of FIG. 2a. The vehicle 200 may also have a first rear-facing camera system 210d arranged to capture images at a rear surface of the vehicle 200. The first rear-facing camera system 210d may be a human vision-based camera system, such as a reversing camera. The vehicle 200 may also have a second rear-facing camera system 210e located at the rear surface of the vehicle 200. The second rear-facing camera system 210e may be part of an environmental perception-based camera system. The first and second rear-facing camera systems may be a combined system.

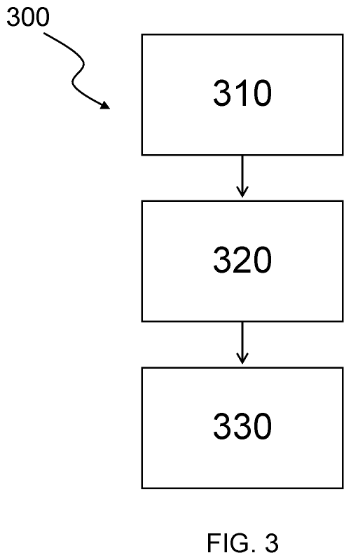

FIG. 3 is a flowchart 300 according to an embodiment of the invention. The flowchart 300 illustrates steps performed by the control system 100 in controlling a camera system of the vehicle 200. At step 310, the control system 100 is configured to receive motion data of the vehicle 200. The motion data is received as an input signal 160 at the input means 140 of the controller 110 and comprises data indicative of one or more motion characteristics of the vehicle 200 as measured by one or more vehicle motion sensors of the vehicle 200. As described below, the motion data may include a vehicle speed and/or a vehicle steering angle.

At step 320, the control system 100 determines whether to operate the camera system of the vehicle 200 in a fixed exposure/aperture control mode or an automatic exposure/aperture control mode using the motion data. The processing means 120 receives the input signal 160 from the input means 140 and, upon executing the instructions stored in memory means 130, determines whether the camera system of the vehicle 200 should be operated in the fixed exposure/aperture control mode or the automatic exposure/aperture control mode based on the motion data.

For example, on one hand, if the motion data indicates that the vehicle 200 is travelling at a relatively high speed, then operating the camera system in the automatic exposure/aperture control mode could lead to images being captured by the camera system having undesirable levels of motion blur. Similarly, motion blur artefacts will also typically tend to increase in prevalence as the steering angle of the vehicle 200 increases, causing turning or latitudinal motion of the vehicle (i.e., motion blur artefacts will be relatively higher when navigating a sharp corner than when navigating a minor bend in an otherwise straight road). If one or both of vehicle speed and vehicle steering angle are relatively high, then operation in the automatic exposure/aperture control mode is unlikely to be suitable as high levels of motion blur may be present in any captured images. In such situations of one or more of high speed and high steering angle of the vehicle 200, the controller 110 is arranged to output a control signal 170 to operate the camera system in a fixed exposure/aperture control mode to limit the level of motion blur in captured images.

On the other hand, if the motion data indicates that the vehicle 200 is travelling at a relatively low speed and with a relatively low steering angle, then operating the camera system in the fixed exposure/aperture control mode could lead to images having a reduced signal-to-noise ratio (SNR). Instead, the control system 100 is arranged to determine that the camera system of the vehicle 200 should be operated in the automatic exposure/aperture control mode, in which a relatively longer exposure time or larger aperture or combination is used by the camera system when compared to the fixed exposure/aperture control mode (where the exposure time/aperture size is limited to compensate for motion blur). As motion blur is less prevalent at relatively lower speeds and relatively lower steering angles, by operating the camera system in the automatic exposure/aperture control mode, images can be captured having a higher SNR.

Of course, situations will arise when the vehicle 200 is travelling with relatively low speed but a relatively high steering angle, and vice versa. As an illustrative example, consider a driver manoeuvring the vehicle 200 using a rear-view camera system such as a reversing camera. If the driver is reversing the vehicle into a parking space, the motion data received by the controller 110 will likely indicate that the vehicle 200 is travelling at relatively low speed. The motion data may also indicate that the vehicle 200 has a high steering angle (e.g., if the driver applies full steering lock to manoeuvre the vehicle 200 into the parking space). However, in this scenario, as the vehicle speed is likely to be very low (i.e., only a few miles per hour), unacceptable levels of motion blur are unlikely to be caused by the application of full steering lock. The processing means 120 is arranged therefore to determine to operate the rear-view camera system in the automatic exposure/aperture control mode. As such, images may be captured by the rear-view camera system that have a high SNR, thus allowing images to be provided to the driver having enhanced levels of detail. This allows the driver to understand the environment around the rear of the vehicle 200 more clearly identify any obstacles accurately, such as neighbouring vehicles, pedestrians, and the kerb.

Once the processing means 120 has determined whether to operate the camera system of the vehicle 200 in the fixed exposure/aperture control mode or the automatic exposure/aperture control mode, the controller 110 outputs, at step 330, a control signal 170 to cause the camera system to operate in the fixed exposure/aperture control mode or the automatic exposure/aperture control mode.

The control signal 170 may be outputted by the controller 110 to an automatic exposure/aperture control module within the camera system of the vehicle 200 or a separate module depending on the implementation. Upon receipt of the control signal 170, the automatic exposure/aperture control module causes the camera system to operate in the automatic exposure/aperture control mode as is known in the art. The control signal 170 may cause the automatic exposure/aperture control module to instruct the camera system to operate in the fixed exposure/aperture mode. The settings for the fixed exposure/aperture control mode may be provided by the control signal or may be known by the camera system or the automatic exposure/aperture control module as appropriate.

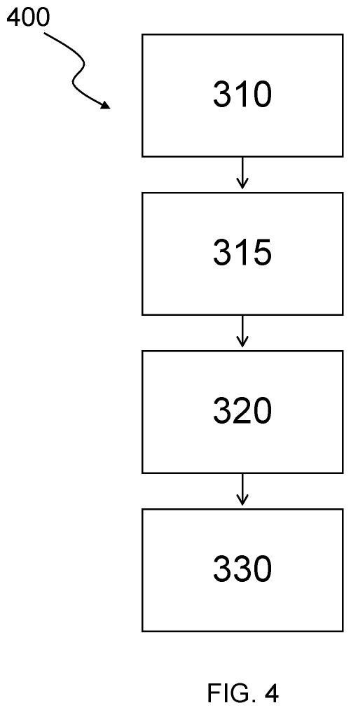

FIG. 4 is a flowchart 400 according to an embodiment of the invention. The flowchart 400 illustrates steps performed by the control system 100 in controlling a camera system of the vehicle 200. Steps 310, 320 and 330 are the same as illustrated for FIG. 3 and their discussion is not repeated in detail for brevity. However, flowchart 400 illustrates an additional step 315 at which the control system 110 is configured to compare the motion data received (at step 310) to a threshold to determine (at step 320) whether to operate the camera system of the vehicle 200 in the fixed exposure/aperture control mode or the automatic exposure/aperture control mode.

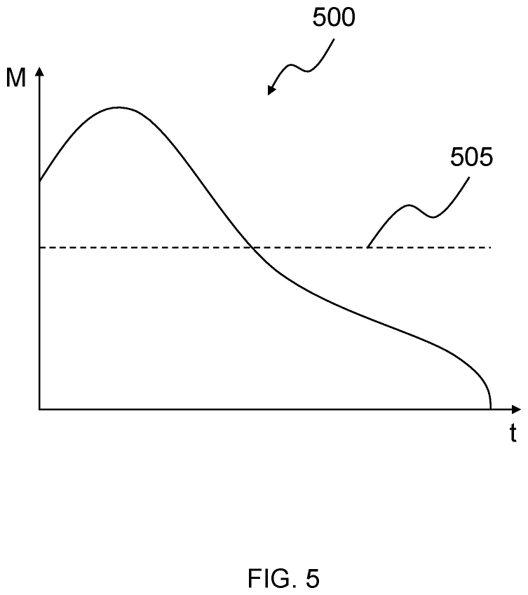

As an example, FIG. 5 shows a graph 500 illustrating how the motion data (M) might vary as a function of time (t). A dotted line is provided on the graph 500 to represent a threshold 505 for the motion data. The threshold 505 indicates a switching point between operation in the fixed exposure/aperture control mode or the automatic exposure/aperture control mode. For example, the controller 110 may output a control signal 170 requesting the camera system to operate in the automatic exposure/aperture control mode upon determination that the motion data reaches or falls below the threshold 505. Conversely, the controller 110 may output a control signal 170 requesting the camera system to operate in the fixed exposure/aperture control mode upon determination that the motion data is above the threshold 505.

The threshold 505 may be for vehicle speed only, may be for steering angle only, or may be a combined threshold for vehicle motion, for example a combined threshold for a function of vehicle speed and steering angle. If the vehicle speed and the vehicle steering angle are both relatively low, then motion blur is unlikely to be a limiting factor and the control system can determine that the camera system should be operated in the automatic exposure/aperture control mode to obtain images having a higher SNR. If the vehicle motion data indicates that the vehicle speed is relatively low and the vehicle steering angle is relatively high (or vice versa) then the threshold applied to a function of both the vehicle speed and the vehicle steering data would indicate that images are captured in the automatic exposure/aperture control mode to have higher SNRs and acceptable levels of motion blur. Of course, exceeding the threshold would trigger the fixed exposure/aperture control mode.

The threshold 505 may be set such that a level of motion blur in the automatic exposure/aperture control mode does not exceed a motion blur threshold. For example, the motion blur threshold may define an upper limit for acceptable levels of motion blur in an image captured by the camera system to be provided to a driver of the vehicle 200. As described above, levels of motion blur will generally be higher in images captured at relatively higher vehicle motion (determined by speed and vehicle steering angle). As such, the threshold 505 may define a vehicle motion below which operation in the automatic exposure/aperture control mode yields images captured by the camera system that benefit from a higher SNR but have acceptable levels of motion blur, and above which operation in the fixed exposure/aperture control mode yields images with reduced motion blur.

To prevent repeated switching between the automatic exposure/aperture control mode and the fixed exposure/aperture control mode when the motion data is hunting around the threshold, a deliberate hysteresis may be introduced by setting the threshold 505 to a first value when the motion data is indicative of increasing vehicle motion and to a second value, different to the first value, when the motion data is indicative of decreasing vehicle motion.

The examples discussed above have focussed on vehicle motion (e.g., speed and/or steering angle) as an important variable when considering levels of motion blur in captured images and have outlined that at relatively higher levels of vehicle motion, operation of the camera system in the automatic exposure/aperture control mode (e.g., at relatively longer camera exposure times) can lead to images being captured having unacceptable levels of motion blur. However, ambient light levels in an environment surrounding the vehicle can also be an important factor when determining whether to operate the camera system in the fixed exposure/aperture control mode or the automatic exposure/aperture control mode.

Generally speaking, increasing camera exposure times at relatively low levels of ambient light is beneficial to increase the SNR of captured images, for example in order to help reveal details of a dark scene. However, if the vehicle 200 is travelling in a low ambient light level environment, increasing the camera exposure time (to account for the low ambient light level) can lead to artefacts such as motion blur occurring in captured images when the vehicle motion is the same. As such, an ambient light level of the environment surrounding the vehicle 200 is a further variable to be considered when determining whether to operate the camera system in the automatic exposure/aperture control mode or the fixed exposure/aperture control mode.

FIG. 6 illustrates a vehicle 200 according to an embodiment of the present invention. The vehicle 200 comprises the controller 110 and camera systems 210a-210c shown by FIG. 2, but additionally has an ambient light sensor 220 for sensing ambient light levels in an environment surrounding the vehicle 200. FIG. 5 shows that the ambient light sensor 220 is located under a windscreen 230 of the vehicle 220, however the ambient light sensor 220 may also be located elsewhere on the vehicle 200. The ambient light sensor 220 may also form part of one or more of the camera systems 210a-210c.

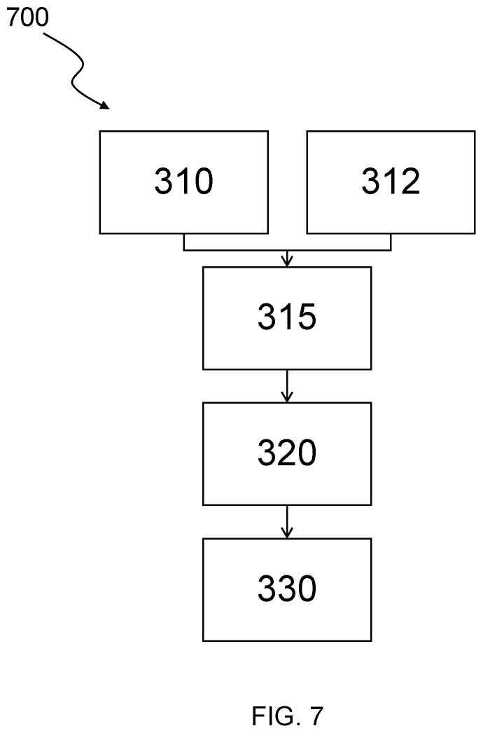

FIG. 7 is a flowchart 700 according to an embodiment of the invention that illustrates steps performed by the control system 100 in controlling a camera system of the vehicle 200. Compared to FIGS. 3 and 4, the flowchart 700 of FIG. 7 contains a further step 312 at which the control system 100 optionally receives ambient light data of an environment surrounding the vehicle 200 in addition to receiving motion data at step 310. The ambient light data is received from the ambient light sensor 220, which, as described above, may be mounted on the vehicle 200 (e.g., under the windscreen 230 or elsewhere on the vehicle 200) or may also form part of one or more of the camera systems 210a-210c. In the latter case, an image sensor of the one or more camera systems 210a-210c may act as the ambient light sensor 220 to sense ambient light levels in the environment surrounding the vehicle 200 based on a level of saturation of pixels in the image sensor. The ambient light sensor 220 is configured to transmit the ambient light data to the control system 100. The control system 100 is configured to receive the ambient light data as ambient light signal 165 (see FIG. 1) at the input means 140 of controller 110.

As described above with respect to the flowchart 400 of FIG. 4, at step 315, the control system is configured to compare the motion data received at step 310 to a threshold 505 to determine at step 320 whether to operate the camera system in the automatic exposure/aperture control mode or the fixed exposure/aperture control mode. However, ambient light data of an environment surrounding the vehicle 200 received at step 312 can cause the threshold at which the control system 100 determines whether the camera system should be operated in the automatic exposure/aperture control mode or the fixed exposure/aperture control mode to be modified.

At relatively low levels of ambient light, camera exposure times or aperture size may need to be increased to enhance the SNR or quality of captured images. However, as vehicle motion increases, an increased camera exposure time can lead to increased motion blur. By determining the threshold 505 using a threshold function based on the ambient light data received at step 312, the control system 100 can determine (at step 320) an appropriate dynamic switching point for operation in the automatic exposure/aperture control mode that strikes a balance between images having an enhanced signal to noise ratio and reduced levels of motion blur. For example, if the ambient light data received at step 312 indicates a relatively low ambient light level in the environment surrounding the vehicle 200, the threshold 505 may be reduced such that the vehicle motion (as indicated by vehicle motion data received at step 310) must be at a lower value before the control system 100 will determine that the camera system can be operated in the automatic exposure/aperture control mode, and vice versa. In other words, the switching point for operation in the automatic exposure/aperture control mode may occur at relatively lower vehicle motion at night-time when compared to relatively higher vehicle motion on a bright sunny day, Once the determination has been made at step 320, the control system 100 proceeds to step 330 and outputs a control signal 170 requesting that the camera system operates in the automatic exposure/aperture control mode or the fixed exposure/aperture control mode accordingly.

If the ambient light data indicates that the environment surrounding the vehicle 200 is particularly dark (for example, at night-time in rural areas), then rather than using the threshold function described above, a predetermined minimum ambient light value may instead be specified, below which operation in the automatic exposure/aperture mode would not be requested no matter the motion of the vehicle as this would be unsuitable owing to a risk of unacceptable motion blur levels in images captured whilst manoeuvring the vehicle 200. If the control system 100 determines at step 320 that the ambient light data received at step 312 is below the predetermined minimum ambient light value, then the control system 100 will output (at step 330) a control signal 170 requesting that the camera system operates in the fixed exposure/aperture control mode.

It will be appreciated that various changes and modifications can be made to the present invention without departing from the scope of the present application.

While the above-described embodiments recite automatic and fixed exposure/aperture control modes, typically only exposure may be controlled.

While the above examples describe the control system 100 determining whether to operate the camera system of the vehicle 100 in the fixed exposure/aperture control mode or the automatic exposure/aperture control mode, based on motion data that comprises both vehicle speed data and vehicle steering angle data, it should be appreciated that the determination may be based on the vehicle speed data only, or on the vehicle steering data only.

For purposes of this disclosure, it is to be understood that reference to ‘the control system being configured to’ is to be understood to mean ‘the one or more controllers of the control system are collectively configured to’. The controller(s) described herein can each comprise a control unit or computational device having one or more electronic processors, the one or more processors collectively configured to perform the control system functionality set out in the control system claims.

1. A control system for controlling a camera system of a vehicle, the control system comprising one or more controllers, the control system configured to:
receive motion data of the vehicle;
determine whether to operate the camera system of the vehicle in a fixed exposure control mode or an automatic exposure control mode using the motion data (“a determination”); and
output, to the camera system of the vehicle, a control signal to request the camera system to operate in the fixed exposure control mode or the automatic exposure control mode in accordance with the determination.

2. The control system of claim 1, wherein the control system is configured to compare the motion data to a threshold to determine whether to operate the camera system of the vehicle in the fixed exposure control mode or the automatic exposure control mode.

3. The control system of claim 2, wherein the control system is configured to output a control signal to request the camera system to operate in one of the automatic exposure control mode and the fixed exposure control mode when the motion data is below the threshold and to operate in the other of the automatic exposure control mode and the fixed exposure control mode when the motion data is above the threshold.

4. The control system of claim 3, wherein the threshold is set such that a level of motion blur in the automatic exposure control mode does not exceed a motion blur threshold.

5. The control system of claim 2, wherein the threshold is at a first value when the motion data is indicative of increasing vehicle motion and at a second value when the motion data is indicative of decreasing vehicle motion.

6. The control system of claim 1, wherein the determination causes the control signal to request the camera system to operate in the automatic exposure control mode at lower vehicle motion than the fixed exposure control mode.

7. The control system of claim 1, wherein the control system is further configured to receive ambient light data of an environment surrounding the vehicle, and wherein the determination is based on the motion data and the ambient light data.

8. The control system of claim 7, wherein the control system is configured to determine the threshold using a threshold function based on the ambient light data.

9. The control system of claim 8, wherein when the ambient light data indicates relatively low ambient light, the threshold is reduced so that the motion data is at a lower value before the determination causes the control signal to request the camera system to operate in the automatic exposure control mode.

10. The control system of claim 7, wherein the determination causes the control signal to request the camera system to operate in the automatic exposure control mode based on the motion data only when the ambient light data is greater than a predetermined ambient light level.

11. The control system of claim 1, wherein the motion data comprises vehicle speed data and vehicle steering data.

12. The control system of claim 1, wherein the camera system is one or more of:
a human vision camera system;
a rear-view human vision camera system;
a three-dimensional surround view camera system; and
an environmental perception camera system.

13. A system comprising the control system of claim 1 and one or more cameras mounted on a vehicle.

14. A vehicle comprising the system of claim 13.

15. A method for controlling a camera system of a vehicle, the method comprising the following steps:
receiving, at a control system, motion data of the vehicle;
determining, by the control system, whether to operate the camera system of the vehicle in a fixed exposure control mode or an automatic exposure control mode using the motion data; and
outputting, by the control system to the camera system, a control signal to operate the camera system in the fixed exposure control mode or the automatic exposure control mode in accordance with the determining step.

16. Computer readable instructions which, when executed by a computer, are arranged to perform a method according to claim 15.
